(19) United States
(12) Patent Application Publication
(10) Pub. No.: US 2025/0190733 A1
(43) Pub. Date: Jun. 12, 2025

(54) SYSTEM AND METHOD FOR SECURE SHIPPING CONTAINER MANAGEMENT USING MULTI-WINDOW DISPLAYS

(71) Applicant: Altura Innovations, LLC, Mobile, AL (US)

(72) Inventor: Robert B. Hanson, II, Mobile, AL (US)

(73) Assignee: Altura Innovations, LLC, Mobile, AL (US)

(21) Appl. No.: 19/048,440

(22) Filed: Feb. 7, 2025

Related U.S. Application Data
(60) Provisional application No. 63/608,178, filed on Dec. 8, 2023.

(51) Int. Cl. G06K 19/06; G06Q 10/083

(52) U.S. Cl. CPC G06K 19/06009; G06Q 10/083

(57) ABSTRACT

A system and method are provided for enhancing the management and operation of shipping containers through the implementation of an integrated secure multi-window display system. The system comprises a secure multi-window display interface that integrates various aspects of shipping container management. These aspects include tracking of containers, inventory management, logistical scheduling, and automated container handling systems, import and export controls compliance, etc. The interface displays this information across multiple secure windows, enabling efficient and simultaneous monitoring of different container-related parameters.

### CROSS REFERENCES

This application claims priority to U.S. Provisional Application Ser. No. 63/608,178, filed on Dec. 8, 2023, in which application is incorporated herein in its entirety by reference.

### FIELD OF THE DISCLOSURE

The present disclosure is generally related to a system and method for the integrated management and real-time operation of shipping containers, utilizing a secure multi-window display interface.

### BACKGROUND

In the realm of shipping container management, the industry grapples with the intricate coordination of multimodal transport systems, the complexity of global trade networks, and the relentless demand for timely delivery. These challenges are exacerbated by the manual processes that dominate the tracking and management of container fleets, leading to inefficiencies, errors, and heightened costs. With the proliferation of international trade, the volume of containers circulating globally has surged, necessitating enhanced management systems that can cope with the scale and speed required. Traditional methods often fail to provide the real-time data and analytics needed to optimize routing, loading, and unloading operations.

Furthermore, the shipping industry must navigate an ever-changing landscape of regulatory compliance, security concerns, and environmental considerations. Ensuring the integrity of cargo and adherence to international laws and standards, while maintaining cost-effectiveness, is no small feat. The lack of an integrated system for real-time visibility and control leaves operators and logistics managers in the dark, unable to preempt issues or respond rapidly to unforeseen disruptions. This disconnect hinders the capacity to implement proactive strategies and undermines the potential benefits of collaborative logistics.

The present disclosure addresses these gaps. By consolidating key data streams into a unified interface, the system provides a holistic view of container statuses, locations, and logistics schedules. The multi-window capability allows for parallel monitoring and analysis of various aspects of container management, from individual container health to fleet-wide movements. This centralized view is instrumental in enabling stakeholders to make informed decisions swiftly, be it rerouting due to delays or reallocating resources to meet demand surges. In a landscape where timing is everything, the agility afforded by such a system is invaluable. The advanced authentication methods integrated into the system, including biometric recognition and secure ID verification, ensure that data security is not sacrificed for efficiency. In an industry where confidentiality and compliance are paramount, the ability to restrict sensitive information to authorized personnel is critical. The system's design aligns with the maritime sector's shift towards digitalization and automation, setting the stage for the next generation of smart, interconnected, and autonomous shipping operations. It provides the much-needed foundation for the digital transformation that is reshaping the shipping industry, making it more resilient, agile, and sustainable.

### DESCRIPTIONS OF THE DRAWINGS

FIG. 1: Illustrates a secure multi-window display system for shipping containers, according to an embodiment.

FIG. 2: Illustrates a Secure Casting Network, according to an embodiment.

FIG. 3: Illustrates a Security Module, according to an embodiment.

FIG. 4: Illustrates a Manifest Module, according to an embodiment.

FIG. 5: Illustrates a Shipping Module, according to an embodiment.

FIG. 6: Illustrates a Context Awareness Module, according to an embodiment.

FIG. 7: Illustrates a Multi-Window Module, according to an embodiment.

### DETAILED DESCRIPTION

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

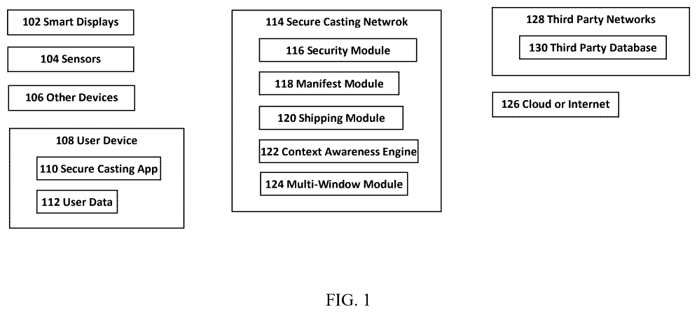

FIG. 1. illustrates a secure multi-window display system for shipping containers. This system comprises smart displays 102 are specialized display units integrated within the system. Equipped with one or more processors, a graphical display unit, and memory, each smart display 102 is capable of rendering primary and secondary data windows on a single device or across multiple interconnected devices. Upon successful multi-layer authentication involving pattern recognition and permission-level verification, authenticated users may send computer-readable signals to generate a primary media window and optionally one or more contextually aware secondary windows. These secondary windows securely interact with the primary media window and other secondary windows, recognizing and responding to their content and context, thereby enabling a customized multi-window display experience.

Sensors 104 are measurement devices for quantifying at least one physical characteristic such as temperature, location, acceleration, orientation, sound level, light intensity, force, capacitance, etc. A sensor 104 may be integrated into a user device 108, such as an accelerometer in a mobile phone, or may be a standalone device. Other devices 106 may include devices other than smart displays 102 or user devices 106 which may serve as primary devices or sources of data, and secondary devices, such as smart displays 102 or user devices 108. Examples of other devices 106 may include desktop computers or servers as primary devices. Likewise, GPS, terminals in vehicles or vessels, and other proprietary portable devices, may be examples of secondary devices. Such devices may also be considered or function as smart displays 102. In some embodiments, other devices may comprise displays or other equipment which may be integrated into a shipping container, or equipment which may be used by customs agents or other regulatory authorities to perform inspections on cargo in shipping containers.

The user device 108 may be computing platforms such as smartphones, tablets, or computers, and serves as a remote interface for interaction with the disclosed system for secure multi-window displays in a shipping environment. Through a multi-layer authentication process, which includes both pattern recognition and permission-level verification, a user device 108 enables authenticated users to transmit computer-readable signals to the system. These signals initiate the casting of primary and secondary data windows across one or more display devices within the shipping network. Additionally, a user device 108 supports the secure and context-aware augmentation of these data windows, allowing for interactions among them based on their content and context.

The secure casting app 110 on the user device 108, is a software interface for enabling the secure management and presentation of multi-window displays in a shipping environment. Upon successful completion of a multi-layer authentication process, which comprises pattern recognition, such as, for example, directing a camera component of the user device 108 at a QR code displayed on smart displays 102 and permission-level verification, the secure casting app 110 facilitates the transmission of computer-readable signals to the system. These signals control the casting of primary and secondary data windows either on a single display device or across multiple display devices. The secure casting app 110 ensures that secondary windows are securely context-aware, enabling them to recognize and respond to the content and context of other active windows in the system. This inter-window interaction capability allows authenticated users to customize their multi-window display experience while maintaining data security.

The user data 112, stored on the user device 108, consists of various sets of information required for the secure presentation of multi-window displays within the system. This data is necessary for the multi-layer authentication process, contributing to pattern recognition and permission-level verification components. Once authenticated, user data 112 can be invoked to generate computer-readable signals that instruct the system in creating and managing primary and secondary data windows. Specifically, user data 112 may contain contextual and content-specific preferences that influence the behavior of secondary windows in securely recognizing and responding to the active windows within the system.

A secure casting network 114 initiates a security module 116 to authenticate at least one user and establish a secure connection and session between a user device 108 and a smart display 102. A secure session is received and the manifest module 118 is initiated which queries at least one third-party database 130 for shipment data relating to one or more shipping containers which is used to generate a manifest. The manifest is received and the shipping module 120 is initiated which updates the manifest with route data. An updated manifest is received and the context awareness module 122 is initiated which queries third-party databases 130 for secondary data and configures one or more context aware triggers to indicate when secondary data should be displayed via a secondary window which are associated with a shipping container, route, and/or secondary data. The manifest is updated when received and the multi-window module displays primary data in a primary window of a smart display 102 and displays secondary data in a secondary window based on at least one context aware trigger.

A shipping container status is received. If the shipping container status indicates that all shipping containers on the manifest have arrived at their destination, have completed customs and other regulator inspections, etc., the process ends, otherwise the manifest module 118 is initiated. The security module 116 receives user credentials and executes a multilayer authentication of the user's credentials. A smart display is linked to the secure casting network 114 and permissions are verified for one or more users. The signal transmission between a primary device, such as a user device 108, and a secondary device, such as a smart display 102, and enable access to the authorized users. Secure content and contextual data is synchronized between primary and secondary windows and the secure session is sent to the secure casting network 114. The manifest module 118 receives a shipment request and queries a third-party database 130 for shipment data. The shipment data is used to generate a manifest comprising at least a list of shipping containers to be shipped which is sent to the secure casting network 114.

The shipping module 120 receives a manifest and selects a first shipping container. The route for the vehicle, vessel, craft, etc. transporting the shipping container is adjusted. The route may further be optimized for one or more factors, such as minimizing cost, maximizing profits, improving fuel efficiency, etc. The shipping container is further assigned a location within the vehicle, vessel, craft, etc. and the manifest is updated. The process is repeated for all shipping containers on the manifest and the updated manifest is sent to the secure casting network 114.

The context awareness module 122 receives a manifest, selects a first shipping container, and queries at least one third-party database 130 for data related to the selected shipping container and/or the route. Relevant data is assigned to the selected shipping container and/or the route and is configured to be displayed on a secondary device such as a smart display 102 as secondary data. Context aware triggers are additionally configured and associated with the secondary data and the selected shipping container and/or route and the manifest is updated. The process is repeated for all shipping containers on the manifest and the updated manifest is sent to the secure casting network 114.

The multi-window module 124 displays primary data to a primary window and polls sensors and one or more third-party networks 128 to monitor for one or more context aware triggers. Secondary data related to one or more of a shipping container, route, and context aware triggers is selected and displayed via a second window. The context aware trigger may comprise a customs inspection request, and the secondary data may relate to relevant customs regulations and inspection procedures. In some embodiments, the secondary data may comprise relevant import or export restrictions. A shipping container status is sent to the secure casting network 114. A cloud 126 is a distributed network of computational and data storage resources which may be available via the internet or by a local network. A cloud 126 accessible via the internet is generally referred to as a public cloud whereas a cloud 126 on a local network is generally referred to as a private cloud. A cloud 126 may further be protected by encrypting data and requiring user authentication prior to accessing its resources. A third-party network 128 is comprised of one or more network resources owned by another party. For example, a third-party network 128 may refer to a manufacturer or other supplier, weather service, port authority, customers agencies, transportation companies, etc. A third-party database 130 stores data owned by another party. For example, a third-party database 130 may store data on a third-party network 128, or may alternatively comprise weather data, manufacturer data, etc.

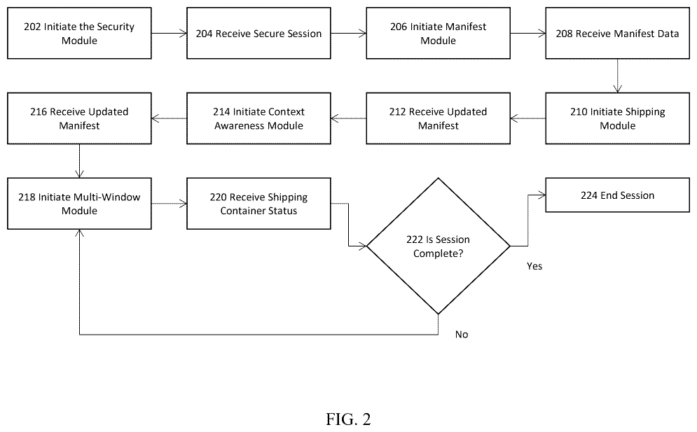

Functioning of the secure casting network 114 will now be explained with reference to FIG. 2. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

This figure illustrates the secure casting network 114. The process begins at initiating at step 202, the security module 116. The security module 116 receives user credentials and executes a multilayer authentication process for at least one user and establishes a link between a primary device and a secondary device. A primary device may be a user device 108 and a secondary device may be a smart display 102. Permissions for the one or more users are verified and the signal transmission is validated to establish a secure connection and enable access to the authorized users. Content is further synchronized between primary and secondary windows on the secondary device.

Receiving at step 204, a secure session from the security module 116. The secure session may comprise an authentication token which may be stored on each device for the duration of the secure session. Initiating at step 206, the manifest module 118. The manifest module 118 receives a shipment request and queries a third-party database 130. Shipment data is received, such as a list of shipping containers to be transported and may additionally comprise a manifest for each shipping container comprising the contents of each shipping container. Receiving at step 208, a generated manifest from the manifest module 118. Initiating at step 210, the shipping module 120. The shipping module 120 receives a manifest and selects a shipping container. The route is updated, and the shipping container is assigned a location within the vehicle, vessel, craft, etc. and the manifest is updated. The process is repeated for all shipping containers on the manifest.

Receiving at step 212, an updated manifest from the shipping module 120. Initiating at step 214, the context awareness module 122. The context awareness module 122 receives an updated manifest comprising at least a list of shipping containers and a route. A shipping container is selected and at least one third-party database 128 is queried for data relating to the selected shipping container. Associations are created between the received data and the selected shipping container and/or route, and the associated data is configured to be displayed as secondary data. Context aware triggers are further configured to determine when to display the secondary data. The process is repeated for all shipping containers in the manifest. Receiving at step 216, an updated manifest from the context awareness module 122. The updated manifest further comprising context aware triggers and secondary data.

Initiating at step 218, the multi-window module 124. The multi-window module 124 displays data in a primary window and polls sensors 104 for one or more context aware triggers. When a context aware trigger is detected, secondary data is selected related to the context aware trigger which is displayed in a secondary window. In some embodiments, the secondary data may comprise data related to customs, including items to be inspected, procedures for inspections, and data filed by a sender or a recipient of the shipping container. In other embodiments, the secondary data may include intelligent routing to minimize driving and assist new drivers in getting the onload/offload process completed more quickly.

Receiving at step 220, a shipping container status from the multi-window module 124. The shipping container status may comprise a shipping container location. The shipping container status may further comprise a customs process status. Determining at step 222, whether the session is complete. The session is complete if the shipping container status indicates that all shipping containers on the manifest have arrived at their destination and all related customs or other regulatory inspections and approval process have been completed. If the session is not complete, return to step 218, and initiate the multi-window module 124. Ending at step 224, the secure casting session if the session is complete.

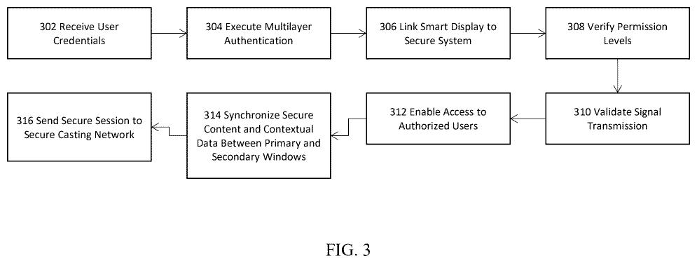

Functioning of the security module 116 will now be explained with reference to FIG. 3. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

This figure illustrates the security module 116. The process begins at receiving at step 302, user credentials. User credentials may comprise a username and password. In some embodiments, the user credentials may comprise a physical or digital user ID. A user ID may store user credentials, such as via RFID, NFC, or other data storage methods. A user ID may alternatively store user credentials via a barcode, QR code, or other physical pattern. Executing at step 304, aa multilayer authentication process. The multilayer authentication process may comprise multiple forms or factors of authentication such as two factor authentication. In an embodiment, the user's credentials, such as a username and password, are checked against at least one database and a second authentication method associated with the received user credentials are checked to verify the user's identity. In some embodiments, the second authentication method may comprise a short message system (SMS) text message sent to a phone number associated with the received user credentials including a code to be entered. Alternatively, a code or link may be sent to an email address associated with the received user credentials. In other embodiments, the second authentication method may comprise a physical user ID, key fob, biometric data, etc. Biometric data may comprise any of fingerprints, retinal scans, face scans, etc. In further embodiments, more than two factors may be required to authenticate the user.

Linking at step 306, a smart display 102 to display secured data. Linking a smart display 102 may comprise completion of an authentication task such as by using pattern recognition mechanisms. Pattern recognition mechanisms may comprise QR code identification, or provision of a displayed identification code to establish a secure connection between the smart display 102 and a secure system. Identification of the smart display 102 allows for the validation of the smart display 102 and activation of functionalities on either a primary or secondary screens. A primary screen may be the display of a user device 108, and a secondary screen may be a smart display 102. In an embodiment, a smart display 102 displays a QR code which is then scanned by user device 108, such as via a camera integrated in or attached to the user device 108. The data stored in the QR code may then be used by a secure casting app 110 to identify and authenticate the smart display 102. The user device 108 may then cast content securely on the smart display 102. In an embodiment, a smart display 102 may be a console or GPS mounted within a delivery truck. In other embodiments, the smart display 102 may be mounted within a long-haul shipping truck. The smart display 102 may similarly be located in any type of vehicle such as automobiles, planes, ships, etc. In some embodiments, the smart display 102 may be portable, such as a second user device 108. The smart display 102 may alternatively be located in stationary locations, such as at a warehouse, airport, train station, etc.

Verifying at step 308, the access and/or security permissions levels for at least one user. In an embodiment, the permissions are verified for the user casting data from a user device 108 to a smart display 102. In other embodiments, the user of a smart display 102 may similarly have their permission levels verified. In such embodiments, the user of the smart display 102 may similarly be authenticated separately from the casting user. In an embodiment, the user of a smart display 102 may be the driver of a delivery truck or another vehicle shipping products and/or materials from an origin point to a delivery point. The permission levels may vary. In some embodiments, the permission levels may allow access to different classifications of data. In other embodiments, the permission levels may allow different actions, such as the ability to cast data from a user device 108 to another device such as a smart display 102, whereas other permission levels may only allow users to view data cast to a device. In some embodiments, permissions may further determine whether data may be edited, deleted, viewed, etc.

Validating at step 310, the signal transmission from a data source to a secondary device such as a smart display 102. Validation of a signal transmission may comprise the transmission of an encrypted signal which is then received, decrypted, and verified against an expected value. In some embodiments, the signal transmission should be validated for bidirectional data transmission. For bidirectional data transmission, when the received signal is received and decrypted, another encrypted signal is generated from the receiving device and sent to the original transmission device which similarly decrypts and verifies the signal against an expected value.

Enabling at step 312, access to one or more windows on the secondary device, such as a smart display 102, after authenticating one or more users and allowing the displaying and interaction with one or more data sources. In some embodiments, the user may only be authorized to interact with part of the data being cast to the secondary device. In such embodiments, multiple windows may be displayed to the user such that one or more windows may display view only data which cannot be interacted with by one or more users of the secondary device, and one or more additional windows may display data which can be interacted with by one or more users of the secondary device, and therefore the user may interact with and make changes to at least the data being viewed and/or how the data is displayed. In some embodiments, each window on the secondary device may require separate or additional user authentication which may depend upon the data being displayed via the window.

Synchronizing at step 314, the content displayed on a first window with the content displayed in one or more secondary windows. The content displayed in the first window may comprise data securely transmitted from a casting primary device to the secondary device which may be, for example, a smart display 102. The data displayed in a secondary window may therefore be related to the data displayed on the primary window. For example, the primary window may display a delivery route for packages to be delivered, and a secondary window may display a map with a prescribed route. In another embodiment, the secondary window may display a map of weather conditions, and other events which may impact a driver's route, such as construction, traffic accidents, etc. Sending at step 316, a secure session to the secure casting network 114. In some embodiments, the secure session may comprise an authentication token, a session cookie, or other digital record storing authentication for the current secure session.

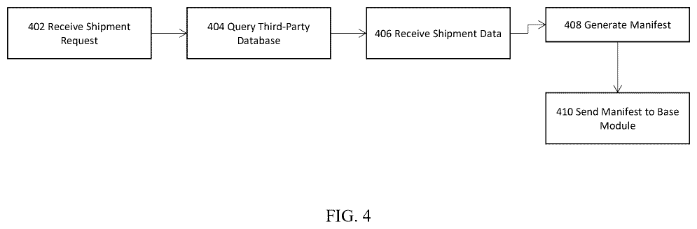

Functioning of the manifest module 118 will now be explained with reference to FIG. 4. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

This figure illustrates the manifest module 118. The process begins at receiving at step 402, a shipment request. A shipment request may comprise at least an origin point or location and one or more destination points or locations. In an embodiment, a shipment request may comprise a request to transport a shipping container loaded with product and/or packages from a warehouse to another warehouse, factory, distribution center, processing facility, etc. The shipping container may be shipped via any transportation method including container ship, rail, truck, plane, etc. A shipping container may refer to a standardized multimodal container, or nonstandard containers or vessels. In some embodiments, the shipping container may include additional equipment and/or sensors to enable environmental controls, such as temperature and humidity control.

Querying at step 404, one or more third party databases 130 for data relating to the shipment request. In an embodiment, the third-party database 130 may comprise a shipping company's shipment tracking database which may communicate via a third-party network 128, such as a global tracking system. Each shipping container may include an identification and/or tracking number and may also include an origination location, destination, and current location. In some embodiments, the third-party database 130 may additionally comprise data relating to the contents of each shipping container. In such embodiments, a different third-party database 130 may be queried, such as a database belonging to a manufacturer, materials supplier, wholesaler, etc. In additional embodiments, third-party databases 130 may comprise customs agencies to facilitate import compliance and customs inspections.

Receiving at step 406, shipment data, such as data related to each item to be transported. In some embodiments, the shipment data may comprise data relating to the product or materials being transported such as weight, materials, etc. Likewise, the shipment data may comprise a plurality of products. The shipment data may be received from multiple databases. Generating at step 408, a manifest for the shipment. The manifest lists and describes each product, material, package, etc. being transported. The manifest may differ based upon the type of shipment, origination point, destination, etc. and the mode of transportation being used. It should be noted that a manifest may be referred to by different names, usually differing based upon transport mode such as a bill of lading. In some embodiments, the manifest may list the products being transported which may further include one or more warnings relating to safety information such as potentially hazardous materials, or products or materials which may require declaration for compliance with import and/or export controls for use by customers inspectors. In some embodiments, a manifest may be generated for the contents of a single shipping container. In other embodiments, a manifest may be generated for several shipping containers with the same origin point or the same destination. In other embodiments, the manifest may list all shipping containers being transported via a single vehicle, vessel, craft, etc. In some embodiments, multiple manifests may be generated. In such embodiments, one or more manifests may be processed similarly and likewise may be processed in parallel or sequentially. Sending at step 410, the generated manifest to the secure casting network 114.

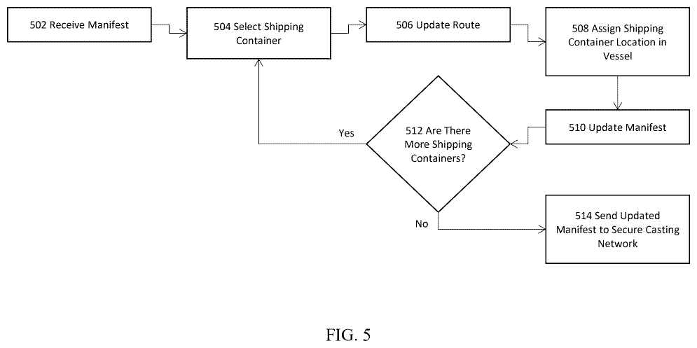

Functioning of the shipping module 120 will now be explained with reference to FIG. 5. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

This figure illustrates the shipping module 120. The process begins at receiving at step 502, a generated manifest. The manifest comprising data describing one or more shipping containers being shipped. For example, the manifest may comprise at least a list of shipping containers and destinations to which they are to be delivered. Selecting at step 504, a first shipping container from a plurality of shipping containers listed on a manifest. In an embodiment, the first shipping container contains lithium-ion batteries. The current destination is listed as the port of Los Angeles. In other embodiments, the selected shipping container may additionally have a final shipping destination, which may include multiple modes of transportation, such as ship, rail, truck, plane, etc.

Updating at step 506, the route of the vehicle, vessel, craft, etc. which will be transporting the shipping container to include the destination of the selected shipping container. In some embodiments, this may further comprise updating a list of shipping containers to be removed from the vehicle, vessel, craft, etc. upon arrival at the destination. In some embodiments, updating the route may further comprise altering the order and/or schedule for arriving at destination locations such as ports, stations, terminals, etc. For example, shipping containers containing perishable cargo may require quicker transport. In some embodiments, the route may be updated based upon optimization algorithms which may optimize for factors such as cost, profit, fuel usage, environmental impacts, scheduling and/or restrictions, etc.

Assigning at step 508, a location within a vehicle, vessel, craft, etc. for the selected shipping container. In some embodiments, a shipping container location may be a specific location to aid efficient operations, such as for unloading shipping containers at a port, station, terminal, etc. upon arrival. In other embodiments, a shipping container location may simply indicate whether the package is on the vehicle, vessel, craft, etc. In some embodiments, the shipping container location may comprise an assigned truck, driver, transport company, etc. who will transport the shipping container. In another embodiment, the shipping container location may be optimized for safety, such as balanced loading and unloading of the vessel or aircraft and for maintaining safe balance during travel.

Updating at step 510, the manifest to include additional shipment and shipping container information. In some embodiments, the updated manifest may include a route of travel from the origin point to the destination which may further indicate shipping containers to be loaded and/or unloaded. Checking at step 512, whether there are additional shipping containers listed on the manifest. If there are more shipping containers, return to step 504 and select another shipping container. Sending at step 514, the updated manifest including additional details about the shipping containers, contents, locations, etc. being shipped and route information to the secure casting network 114.

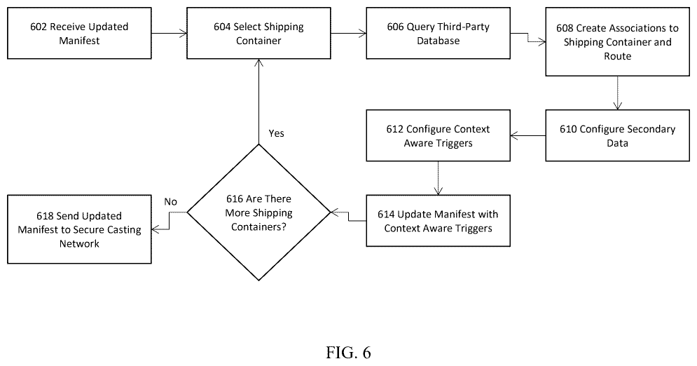

Functioning of the context awareness module 122 will now be explained with reference to FIG. 6. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

This figure illustrates the context awareness module 122. The process begins at receiving at step 602, an updated manifest. The manifest comprising data describing one or more shipping containers being shipped and further including route data. For example, the manifest may comprise at least a list of shipping containers and destinations to which they are to be delivered. Selecting at step 604, a first shipping container from a plurality of shipping containers listed on a manifest. In an embodiment, the first shipping container contains lithium-ion batteries. The shipping container additionally having a route which may comprise a delivery order such that shipping containers earlier in the order are to be delivered earlier in the route, prior to the selected shipping container, and shipping containers later in the order are to be delivered later in the route, after the selected shipping container. In some embodiments, shipping container order may additionally reflect the order in which the shipping containers may be loaded and unloaded at a given location.

Querying at step 606, one or more third party databases 130 for data relating to the selected shipping container. In an embodiment, the third-party database 130 may comprise a database belonging to a manufacturer, materials supplier, wholesaler, etc. In other embodiments, the third-party database 130 may relate to shipment data, such as GPS or map data. In some embodiments, a third-party database 130 may comprise events or conditions which may impact the route specified on the updated manifest. In an embodiment, the third-party database 130 may be a weather database comprising current weather or environmental observations and/or predictions of future weather which may correspond to a planned execution of the route. In an embodiment, the third-party database 130 may comprise a customs database containing regulatory rules and procedures for import and/or export of products and/or materials.

Creating at step 608, one or more contextual associations between the selected shipping container and the data received from the one or more queried third-party databases 130. In an embodiment, an association may comprise data relating to the contents of the shipping container such as weight, potentially hazardous materials, or if the package contains perishable or temperature sensitive contents, etc. In other embodiments, the associations may relate to the package's route, such as a road closure or traffic accident which may impact access to the delivery address, congested shipping lanes, closed ports or airports, etc. In some embodiments, the associations may indicate potential weather-related hazards, such as rain, snow, high winds, tropical cyclones, etc. In an embodiment, associating the contents of a shipping container having lithium-ion batteries with safety data sheets and other manufacturer specification data. In other embodiments, the associations may relate to import or export compliance, such as regulations with which the shipper must comply.

Configuring at step 610, the secondary data associated with the shipping container and formatting the data to be displayed in a second window. In some embodiments, the primary window may be configured to display route data and/or the manifest. The secondary data may be configured in one or more views which may be selectively displayed based upon observed data. For example, a weather map and/or predication and relevant precautionary instructions may be displayed if severe weather is predicted. In other embodiments, the secondary display may regulatory compliance data, such as which contents may be subject to inspection or further scrutiny, or which may require additional approvals, the status of which may or may not be indicated. Likewise, the regulatory compliance information specific to the shipping container may be associated with the shipping container and available to be viewed as secondary data.

Configuring at step 612, one or more triggers for each set of secondary data which may be displayed in a secondary window. In an embodiment, a context aware trigger may be an event, such as a traffic advisory. In another embodiment, a context aware trigger may be predicted and/or observed whether conditions such as a developing tropical cyclone or other severe weather event. In some embodiments, the context aware trigger may be a customs inspection request. Updating at step 614, the manifest with the configured context aware triggers. Checking at step 616, whether there are additional shipping containers listed on the manifest. If there are more shipping containers, return to step 604 and select another package. In some embodiments, shipping containers may be grouped into lots, which may be treated the same as a single shipping container. Sending at step 618, the updated manifest including configured context aware triggers associated with the shipping containers being shipped and route information to the secure casting network 114.

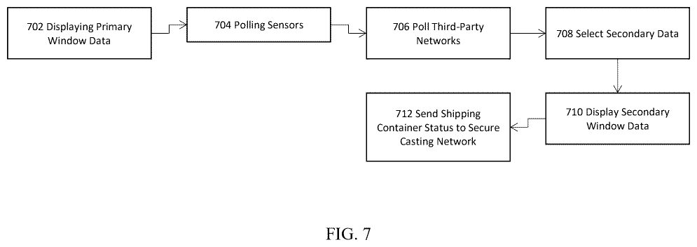

Functioning of the multi-window module 124 will now be explained with reference to FIG. 7. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

This figure illustrates the multi-window module 124. The process begins at displaying at step 702, primary data in the primary window. The primary window may comprise data related to a manifest, such as a list of shipping containers to be transported. Alternatively, the primary window may comprise a map displaying a route and locations where shipping containers are to be delivered. In some embodiments, the primary window data may include a live position of the vehicle, vessel, craft, etc. In some embodiments, the primary window may show multiple types of information relating to the manifest and/or route.

Polling at step 704, one or more sensors 104 to detect contextual trigger events. For example, a sensor 104 may comprise GPS and the contextual trigger may be the current location of the vehicle, vessel, craft, etc., which may be a container ship. In other embodiments, sensors 104 may comprise environmental sensors, such as temperature or humidity. Sensors 104 may alternatively relate to the orientation of a vehicle, vessel, craft, etc. such as pitch, roll, yaw, etc. In other embodiments, sensors 104 may be at a different location than the vehicle, vessel, craft, etc., such as those used to predict weather conditions. In some embodiments, sensors 104 may be integrated into a shipping container. For example, a shipping container may monitor the environment within the shipping container such as for shipping containers which include an environment control system.

Polling at step 706, one or more third-party networks 128 for contextual trigger events and/or data. Examples of third-party networks 128 may include weather forecasting services, maritime authorities, aviation authorities, etc. Contextual trigger events may comprise weather conditions such as developing tropical cyclones or other severe weather. Contextual trigger events may also comprise reports of traffic congestion, such as in shipping lanes or customs inspection requests. In some embodiments, a third-party network 128 may comprise a customs network.

Selecting at step 708, secondary data which is contextually relevant to the data being displayed in the primary window. For example, if the primary window data displays a map and the vehicle, vessel, craft, etc. current location, the secondary data may comprise reports of severe weather and may additionally comprise diversion instructions or recommendations. In some embodiments, the secondary data may relate to customs inspection data. For example, the primary window may display a manifest for a specific shipping container, and the secondary data may comprise data relating to customs, such as information and/or regulations relating to items within the shipping container which may be subject to import or export restrictions. For example, an outbound shipping container may contain technology such as thermal imaging equipment, advanced computer hardware, etc. which may not be exportable to some countries which may include destinations for the shipping container or other shipping containers on the vehicle, vessel, craft, etc. transporting the shipping container. Similarly, an inbound shipping container may contain plants which may not be allowable for import, or which may require isolation for a quarantine period and inspection for invasive pests prior to transit to its final destination. In some embodiments, a shipping container may comprise perishable goods which must be maintained within specific environmental conditions and sensors embedded within the shipping container may have exceeded the acceptable range requiring inspection by customs or another relevant agency, such as the FDA. In some embodiments, the customers data may comprise data provided by a shipper and/or recipient of the shipping container provided for the purposes of customers, which may include, for example, import fees.

Displaying at step 710, secondary data in a secondary window. In an embodiment, the secondary window displaying customs information including information filed by the shipper and/or recipient of the shipping container. Sending at step 712, a delivery status to the secure casting network 114. The shipping container status may comprise the current location of the shipping container. In some embodiments, the shipping container status may additionally comprise the customs status of the shipping container, which may include any of selected for inspection, pending inspection, inspection in progress, inspection complete, inspection failed, inspection passed, etc.

The functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

What is claimed is:

1. A system for presenting data related to shipping container logistics comprising:
a first computing device with a first user interface, wherein the first computing device is configured to connect to a logistics coordinator's user profile,
a second computing device with a second user interface, wherein the second computing device is configured to connect to a user profile of a shipping operator, wherein the user profile contains shipping container data,
a display with a control board operably connected to the first and second computing devices, wherein a processor of the control board is configured to receive first logistics data from the first computing device,
wherein the processor of the control board is also configured to receive second container data from the second computing device,
wherein the processor of the control board organizes the first logistics data and the second container data into multiple display windows within a display user interface of the display,
a communication interface operably connected to the control board, wherein an input device transmits commands to the control board via this communication interface,
wherein the commands instruct the processor on the layout of the display user interface based on the first logistics data and the second container data,
a non-transitory computer-readable medium coupled to the processor, containing instructions that when executed by the processor cause the processor to perform operations including:
receiving the first logistics data and the second container data,
determining the layout of the display user interface based on the commands, the first logistics data, and the second container data,
creating mirrored logistics data based on the display user interface, the first logistics data, and the second container data,
transmitting the mirrored logistics data to a logistics database.
